(19) United States
(12) Patent Application Publication
(10) Pub. No.: US 2016/0347139 A1
(43) Pub. Date: Dec. 1, 2016

(54) TRANSVERSE LEAF SPRING FOR A MOTOR VEHICLE AS WELL AS AXLE ASSEMBLY WITH A TRANSVERSE LEAF SPRING

(71) Applicant: BENTELER Automobiltechnik GmbH, Paderborn (DE)

(72) Inventors: Rodscha DRABON, Salzkotten (DE); Hendrik REINEKE, Bad Driburg (DE); Juergen VON DER KALL, Paderborn (DE); Frank FETSCHER, Hoevelhof (DE); Aloys SCHROEDER, Paderborn (DE); Claus Mehren, Paderborn (DE)

(73) Assignee: BENTELER Automobiltechnik GmbH, Paderborn (DE)

(21) Appl. No.: 15/166,313

(22) Filed: May 27, 2016

(30) Foreign Application Priority Data
May 29, 2015 (DE) 102015108484.8

(51) Int. Cl. B60G 11/08; B60G 9/00

(52) U.S. Cl. CPC B60G 11/08; B60G 9/00; B60G 2206/7101; B60G 2200/30; B60G 2202/114; B60G 2206/428

(57) ABSTRACT

In a transverse leaf spring 2 and an axle assembly 1 for a motor vehicle, transverse leaf spring 2 is curved about the longitudinal direction X of the motor vehicle in the end regions 11 and is curved about the vertical direction Z of the motor vehicle in a central region 10. As a result, optimum potential spring rates and the associated installation space requirement is achieved.

### BACKGROUND OF THE INVENTION

The present invention relates to a transverse leaf spring for a motor vehicle, according to the features disclosed in patent claim 1.

Furthermore, the present invention relates to an axle assembly for a motor vehicle, according to the features disclosed in patent claim 15.

### DESCRIPTION OF PRIOR ART

It is known from the prior art to design wheel suspensions at the axle of a motor vehicle in such a way that a wheel can compress or extend relative to the body of a motor vehicle. For this purpose a spring and optionally a shock absorber are usually provided to absorb the static and dynamic wheel load when the motor vehicle is stationary or running,

The types of springs that are known from the prior art for this purpose include not only coil springs and air springs, but also leaf springs. in the latter case the prior art discloses, in particular, transverse leaf springs that extend, in particular, from one side of the motor vehicle to the other side of the motor vehicle in the region of the axle. The ends of these transverse leaf springs are usually coupled kinematically to guide arms and/or an axle bracket. In one area, which is spaced apart from the ends, the transverse leaf springs are coupled to a subframe of the axle or to the body of the vehicle.

Thus, the objective that is to be achieved in motor vehicles is, in particular, a center of gravity that is as low as possible, for which reason the amount of installation space that is available precisely in the vertical direction of motor vehicles is limited. However, it is usually necessary to mount additional components, such as, for example, a transfer case, in the central region of the axle, so that this transfer case conflicts in terms of the available installation space with the transverse leaf spring.

A transverse leaf spring of this type is known, for example, from the German patent application DE 102 16 244 A1.

### SUMMARY OF THE INVENTION

Therefore, the object of the present invention is to improve a transverse leaf spring in terms of the available installation space and the associated spring properties.

The invention achieves this object with a transverse leaf spring for a motor vehicle, according to the features disclosed in patent claim 1.

Furthermore, the aforementioned object is achieved with an axle assembly for a motor vehicle, according to the features disclosed in patent claim 15.

Advantageous variants of the embodiment of the present invention are the subject matter of the dependent patent claims.

The transverse leaf spring for a motor vehicle, with the transverse leaf spring being made of a fiber reinforced composite material and with the transverse leaf spring having a central region and adjoining end regions being formed with the central region, has a curvature about the longitudinal direction of the motor vehicle and a curvature about the vertical direction of the motor vehicle.

The transverse leaf spring is characterized, according to the invention, by the feature that the curvature about the longitudinal direction of the motor vehicle is formed only in each of the end regions and that the curvature about the vertical direction of the motor vehicle is formed only in the central region.

The coordinate system of the motor vehicle applies to the orientations specified in this application. This means that the longitudinal direction of the motor vehicle is defined as the X direction and is oriented towards the front or towards the rear with respect to the motor vehicle. The transverse direction of the motor vehicle is defined as the Y direction and, as a result, is oriented at right angles to the longitudinal direction from one side of the motor vehicle to the other opposite side of the motor vehicle. The vertical direction of the motor vehicle is the vertical axis Z and is directed so as to he oriented from the top to the bottom with respect to the motor vehicle. Hence, the curvature of the end regions extends downwardly oriented in relation to the vertical direction of the motor vehicle. Then the curvature in the central region about the vertical direction of the motor vehicle points, in particular, with the arc of curvature in the direction of travel or opposite to the direction of travel when the transverse leaf spring is installed.

The longitudinal direction of the motor vehicle may also be referred to as the longitudinal axis of the motor vehicle. The transverse direction of the motor vehicle may also be referred to as the transverse axis of the motor vehicle. The vertical direction of the motor vehicle may also be referred to as the vertical axis of the motor vehicle.

In a particularly preferred embodiment the curvature in the vertical direction of the motor vehicle is formed only in the central region. This means that the central region is not curved about the longitudinal direction of the motor vehicle. Hence, the central region runs linearly, Furthermore, it is especially preferred that the curvature about the longitudinal direction of the motor vehicle is formed only in the end regions. The end regions in turn are not curved about the vertical direction of the motor vehicle. Thus, in this embodiment the end regions are configured to run only in a straight line.

The embodiment, according to the invention, makes it possible to achieve optimal suspension properties with respect to the achievable spring rates or, more specifically, the forces generated by the transverse leaf spring. The curvature in the end regions in relation to the vertical direction of the motor vehicle makes it possible to achieve the necessary spring rates or, more specifically, the forces generated by the transverse leaf spring. Therefore, the curvature about the vertical direction of the motor vehicle in the central region makes it possible at the same time to orient the curvature of the arc in the longitudinal direction of the motor vehicle, to put an axle subframe and/or a transfer case in the central region, in particular, in the region of a straight line that connects the bearing points of the transverse leaf spring. As a result, the conflict of goals caused by the transverse leaf spring precisely in terms of the amount of installation space required by other components is resolved with the transverse leaf spring of the invention. Due to the feature that the transverse leaf spring is made of at least one layer, preferably several layers, of a fiber reinforced composite material, it is possible for the transverse leaf spring to have a three dimensional design or rather a three dimensional shape.

Within the scope of the invention the data with respect to the curvature may relate to the state of the transverse leaf spring in the unloaded state, i.e., prior to assembly in the motor vehicle. However, the data with respect to the curvature may also relate to the transverse leaf spring in the installed state, thus, when a static wheel load is applied to the transverse leaf spring.

Furthermore, the present invention relates to an axle assembly for a motor vehicle, the axle assembly comprising an axle subframe and guide arms, which are mounted in a relatively pivotable manner on the axle subframe. Furthermore, a transverse leaf spring, which is described above, is an essential part of the axle assembly, which is coupled to the guide arms and/or the axle subframe. In addition, the transverse leaf spring has a curvature in the longitudinal direction of the motor vehicle and is coupled in the region of its ends to the guide arms by means of attachment points of the guide arms. In an inner region, which is spaced apart from the ends of the transverse leaf spring, this transverse leaf spring is coupled to the axle subframe and/or the body of a motor vehicle by means of bearing points. The axle assembly is characterized, according to the invention, by the feature that the transverse leaf spring has at least one additional curvature in the vertical direction of the motor vehicle, so that a portion of the axle subframe and/or a transfer case is and/or are arranged at least partially in the region of a straight line connecting the bearing points.

Thus, the axle assembly of the invention makes it possible to establish a new optimum composed of achievable spring rates and spring forces, generated by the transverse leaf spring, in conjunction with the available installation space in the underfloor region of a motor vehicle.

The aforementioned statements regarding the coordinate system of the motor vehicle and the respective state of curvature in the loaded or unloaded state of the spring apply mutatis mutandis. In this case the transverse leaf spring may be considered to be unloaded with the present curvatures when, for example, the motor vehicle is raised onto a vehicle lift. However, it is also possible within the scope of the invention for the aforementioned curvatures to be formed in the transverse leaf spring in the axle assembly when a static wheel load of the motor vehicle is applied to the axle assembly.

In the case of the transverse leaf spring according to the invention, a bearing point is arranged preferably in a transition from the central region to a respective end region. The bearing point may be, in particular, a form fitting bearing, which surrounds the transverse leaf spring on the top side and on the bottom side in relation to the vertical direction of the motor vehicle in the installed position. In particular, rubber bearings or other bearings are disposed, for example, at said bearing point. Preferably the transverse leaf spring may have corresponding convex elements or also concave elements that allow the bearing to encircle in a form fitting manner at the bearing point, so that this arrangement prevents the transverse leaf spring from moving, in particular, in the transverse direction of the motor vehicle. The bearing is preferably designed in such a way that it does not interfere with the wheel. This means that the bearing absorbs in essence only the spring forces, i.e., the forces in the vertical direction of the motor vehicle and, as a result, does not absorb any forces in the transverse direction of the motor vehicle and, in addition, does not absorb preferably any forces in the longitudinal direction of the motor vehicle.

Furthermore, it is particularly preferred that the central section of the transverse leaf spring be designed in a projection on the X-Z plane, defined by the transverse direction of the motor vehicle and the vertical direction of the motor vehicle, in such a way that the central section has a linear progression. This means that the central section is designed so as to be curved about the vertical direction of the motor vehicle only in the transverse direction of the motor vehicle and has, when viewed in the longitudinal direction of the motor vehicle, a linear progression in the transverse direction of the motor vehicle. The purpose of this arrangement is to fulfill the objective that the transverse leaf spring has a particularly flat construction in relation to the vertical direction of the motor vehicle and, thus, does not come into conflict with the underfloor of a motor vehicle or other additional components. In particular, the transverse leaf spring can be disposed underneath the axle subframe in relation to the vertical direction of the motor vehicle.

Furthermore, the end regions have a linear progression in a projection on the X-Y plane that is defined by the longitudinal direction and the transverse direction of the motor vehicle. This means within the scope of the invention that the end regions in the X-Y plane have a linear progression. Thus, in a top view, when viewed in the vertical direction of the motor vehicle, the end regions run in a straight line or, more specifically, are designed to be straight. However, in a view, as seen in the longitudinal direction of the motor vehicle, the end regions extend in such a way that they are curved, so that the curvature occurs about the longitudinal direction of the motor vehicle and, in particular, extends downwards. Owing to the curvature of the end regions and, in particular, the intensity of the curvature of the end regions it is possible to design the spring force, which is generated by the transverse leaf spring during the compression process, in accordance with the requirements of the motor vehicle.

In this context all of the aforementioned curvatures of the transverse leaf spring may have a constant radius of curvature, but may also have a mutually different radius of curvature over the course of the respective curvature.

The transverse leaf spring may have a mutually different cross sectional area, in particular, over its longitudinal extent, That is, the thickness of the transverse leaf spring may vary; and/or the width of the transverse leaf spring may also vary over the longitudinal extent.

In a preferred variant of the embodiment the size of the cross sectional area may be more or less constant over the longitudinal extent of the transverse leaf spring. This means that the width and the thickness vary, but the resulting size of the cross sectional area is constant.

However, in an additional preferred variant of the embodiment the size of the cross sectional area is also different from each other over the longitudinal extent of the transverse leaf spring. In particular, a ratio of the thickness of the transverse leaf spring to the width of the transverse leaf spring is selected in such a way that the thickness is equal to 5% to 50% of the width. If the width of the transverse leaf spring is 100 mm, then the thickness would range from 5 mm to 50 mm. In a preferred variant of the embodiment of the transverse leaf spring a respective end region is adjusted, in particular, in a ratio such that the thickness is equal to 5% to 50% of the width in the end regions. In the central region the spring has a thickness that is equal to 5% to 30% of the width in the central region. This means that if the transverse leaf spring has a width of 100 mm, then this transverse leaf spring has a thickness of 5 mm to 30 mm in the central region.

The longitudinal extent, i.e., the linear progression of the end regions of the transverse leaf spring, is designed, in particular, in such a way that a projection of the longitudinal extent of the end regions on the X-Y plane runs at an angle of 2 deg. to 15 deg., oriented to the transverse direction of the motor vehicle.

In another preferred variant of the embodiment of the transverse leaf spring of the invention, the end regions are designed in such a way that in this case an external end piece, i.e., an external section of the end regions, has in turn a linear progression in the projection on the Y-Z plane that is defined by the transverse direction of the motor vehicle and the vertical direction of the motor vehicle. This linear progression can extend in parallel offset from the course of the projection of the central region on the Y-Z plane. However, the linear progression may also run at an angle thereto.

Furthermore, it is particularly preferred that a projection on a radiant of the transverse leaf spring on the X-Y plane, defined by the longitudinal direction of the motor vehicle and the transverse direction of the motor vehicle, extends at an amount of 10 mm to 150 mm in the longitudinal direction of the motor vehicle.

Furthermore, it is particularly preferred that the central region has a radius of curvature about the vertical direction of the motor vehicle, where in this case the radius of curvature has preferably a geometric length of at least 150 mm to at most 2.000 mm. At the same time the radius of curvature of the central region may have a linear constant progression. Thus, all of the points of the central region have the same radius of curvature. However, the radius of curvature may also be different from each other over the longitudinal extent of the transverse leaf spring in the central region. In particular, the radius of curvature increases from a center point of the central region to the end regions.

Furthermore, the transverse leaf spring has bearing orientations that are intended for attaching the bearings and that extend at an angle of 90 deg. +/−15 deg, relative to a longitudinal extent of said transverse leaf spring. At the same time the angle may be formed in such a way that the angle is oriented in both the longitudinal direction of the motor vehicle and, as an alternative or in addition, also in the vertical direction of the motor vehicle. The term “hearing orientation” may also he construed to mean a bearing axis of rotation, i.e., an axis of rotation, about which a part of the transverse leaf spring rotates during compression or extension.

The attachment of the transverse leaf spring, in particular, at its ends to the axle assembly, may be carried out, for example, by means of a push rod or a pull rod. For this purpose either a receiving opening is introduced into a respective end of the transverse leaf spring; or, as an alternative, a suitable metallic receptacle for coupling to a push rod or a pull rod or a direct attachment to the guide arm may also be glued on, pressed on and/or may be coupled in any other way to a respective end of the transverse leaf spring.

### BRIEF DESCRIPTION OF THE SEVERAL VIEWS OF THE DRAWINGS

Other advantages, features, aspects and properties of the present invention are an integral part of the following description, Preferred variants of the embodiment are depicted in the figures shown in schematic form. These figures are shown only for the sake of a better understanding of the invention, The drawings show in

FIG. 1 a prior art axle assembly in cross sectional with the transverse leaf spring.

FIG. 2 the transverse leaf spring, viewed in the longitudinal direction relative to the motor vehicle.

FIG. 3 inventive transverse leaf spring, viewed in the vertical direction relative to the motor vehicle.

FIG. 4 an alternative variant of the embodiment from FIG. 2 with linear end pieces.

FIG. 5 an alternative variant of the embodiment from FIG. 2.

FIG. 6 a view, according to FIG. 2, with a guide arm of the wheel suspension of the motor vehicle.

FIG. 7 a view, according to FIG. 3, with unidirectional fiber orientation; and

FIGS. 8a and 8b a sectional view along the sectional lines a-a and bb of FIG. 2.

### DETAILED DESCRIPTION OF THE INVENTION

The same reference numerals are used for identical or similar parts in the figures, even if repetition of the description is omitted for the sake of simplicity.

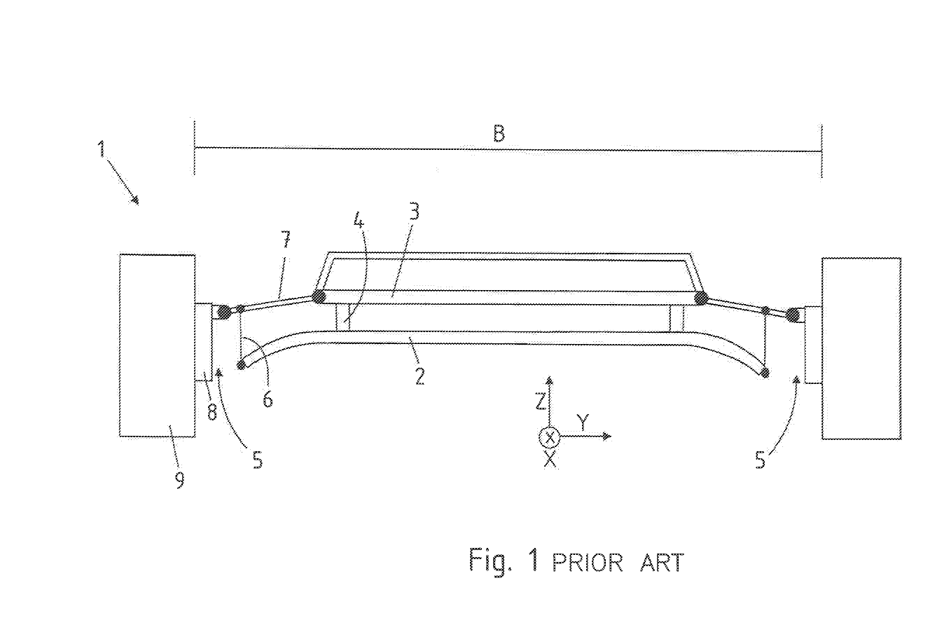

FIG. 1 shows an axle assembly 1 in the same way as it is known from the prior art. For this purpose a transverse leaf spring 2 extends in the transverse direction Y of the motor vehicle over at least a portion of the width B of a motor vehicle that is not shown in greater detail, in addition, the transverse leaf spring 2 is coupled to an axle subframe 3 by means of bearings (not shown in more detail) at bearing points 4. A respective end 5 of the transverse leaf spring 2 has an attachment (not shown in greater detail), for example, a metallic attachment in the form of an eyelet, for coupling to a coupling rod 6. The transverse leaf spring 2 is coupled by means of this coupling rod 6 to a guide arm 7, which is mounted in a relatively moveable manner on the axle subframe 3, or the transverse leaf spring 2 is also attached directly (not shown in greater detail) to the guide arm 7. As a result, the wheels 9, which are mounted on wheel carriers 8, can compress and extend upwards and downwards in relation to the plane of the drawing by way of the axle subframe 3. Owing to the kinematic coupling to the guide arms 7, movement in the transverse and longitudinal direction, according to the requirements with respect to toe and camber, is also possible, For the sake of simplicity only one guide arm 7 is shown here. Usually multiple guide arms are formed on each side with the wheel carrier 8 by means of two, three or more guide arms.

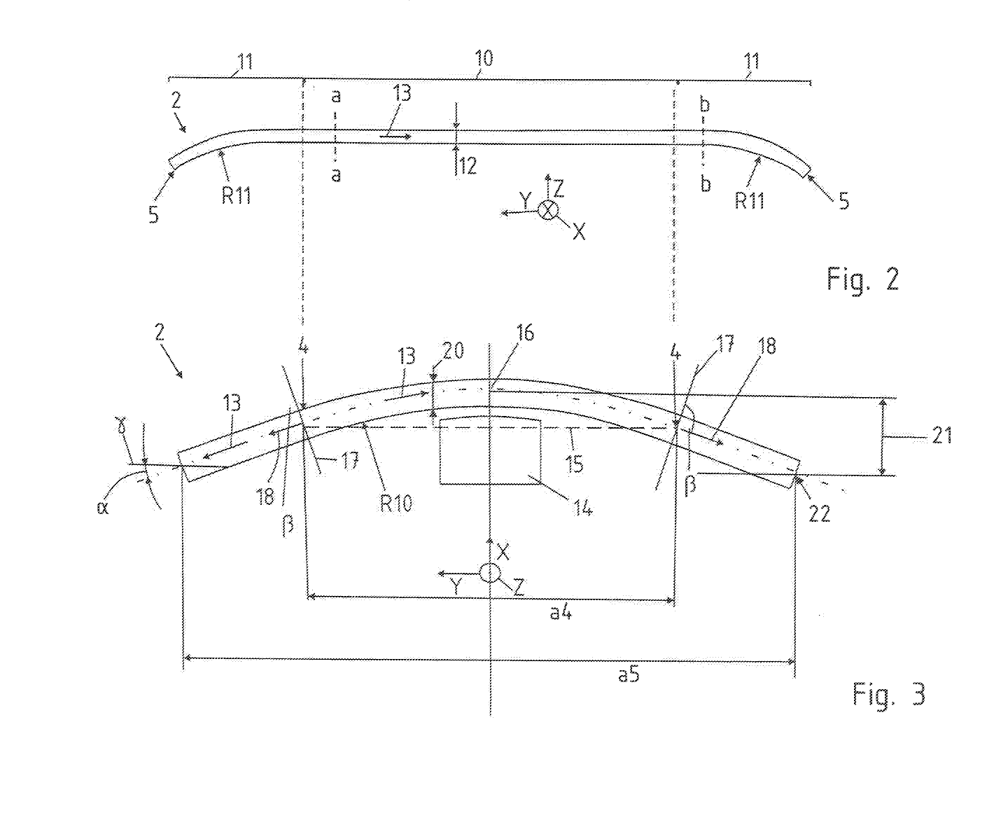

The transverse leaf spring 2 of the invention is shown in a rear view in the longitudinal direction X of the motor vehicle of the vehicle coordinate system, which is arranged, in particular, in the middle of the front axle of a motor vehicle. It can be seen in the embodiment of FIG. 2 that the transverse leaf spring 2 of the invention has a central region 10 and end regions 11, each of which adjoins the central region 10. It is plain to see in FIG. 2 that a projection of the central region 10 on the Y-7 plane, which is defined by the transverse direction Y of the motor vehicle and the vertical direction Z of the motor vehicle, has a linear progression. Furthermore, a radius of curvature R11 is shown in the end regions 11. In this respect the radius of curvature R11 may have a constant arc in the longitudinal direction 13 of the transverse leaf spring 2, hence, from the transition of the central region 10 to the end region 11 as far as up to the end 5. However, within the scope of the invention the radius of curvature R11 may also decrease or increase, i.e., have a mutually different valve.

The end regions 11 are curved about the longitudinal direction X of the motor vehicle. Thus, the end regions 11 and in this embodiment, in particular, the ends 5 of the transverse leaf spring 2 point downwards in relation to the image plane, which also corresponds to the vertical direction 7 of the motor vehicle. In this respect the transverse leaf spring 2 may have a constant thickness 12 over its longitudinal extent 13. However, the thickness 12 may also be designed so as to be different over the longitudinal length. The same applies to the width 20, according to FIG. 3.

FIG. 3 shows a top view of the transverse leaf spring 2, when viewed in the vertical direction Z of the motor vehicle. It is easy to see in this embodiment that the central region 10 has a curvature about the vertical direction Z of the motor vehicle. In this case the arc of the curvature is directed here so as to be oriented in the longitudinal direction X of the motor vehicle, Within the scope of the invention it is also conceivable that the arc of the invention is directed towards the front in the longitudinal direction X of the motor vehicle, i.e., in the direction of travel. However, it is also conceivable within the scope of the invention that the arc of the curvature about the vertical direction Z of the motor vehicle is oriented in the opposite longitudinal direction X of the motor vehicle, i.e., in reverse travel. Precisely this aspect shows a significant advantage of the invention, because a transfer case 14, which is shown only in schematic form, is disposed at least in certain regions on a straight line 15, In this case the straight line 15 connects the bearing points 4 of bearings that are not shown in greater detail. The straight line 15 is a connecting straight line of the bearing points 4 of the bearings, which are not shown in greater detail, and runs in the transverse direction Y of the motor vehicle. Furthermore, the width 20 of the transverse leaf spring 2 is shown.

The radius of curvature R10 of the curvature of the central region 10 is shown. In this case the radius of curvature R10 can be constant over the entire longitudinal extent 13 of the central region 10. However, the radius of curvature R10 may also be designed in such a way that it increases or decreases. In particular, the radius of curvature is designed in such a way that it increases from a center point 16 of the transverse leaf spring 2 to the end regions 11. In addition, the radius of curvature RIO has preferably a length of at least 150 mm and at most 2,000 mm.

The distance a4 between the bearing points 4 is preferably no less than 300 mm and no more than 900 mm. The distance a5 between the ends is preferably no less than 850 mm and no more than 1,600 mm.

Furthermore, it is easy to see in FIG. 3 that the projection of the end region 11 on the X-Y plane, which is defined by the longitudinal direction X of the motor vehicle and the transverse direction Y of the motor vehicle, has a linear progression. Thus, when viewed from the direction according to FIG. 3, the longitudinal extent 13 of the transverse leaf spring 2 in the end regions 11 is designed so as to be linear, For this purpose the longitudinal extent 13 in the end regions 11 is formed, in particular, at an angle α of at least 2 deg. and at most 15 deg. to the transverse direction Y of the motor vehicle in the X-Y plane.

The transverse leaf spring 2 has a bearing orientation 17 at the bearing points 4. In this case the bearing orientation 17 is designed to project preferably at right angles in such a way that it is oriented in relation to the respective longitudinal direction 18 of the transverse leaf spring 2 at the bearing point 4. The angle beta β, which is preferably 90 deg. +/−15 deg., is useful for this purpose.

Furthermore, a radiant 21, which describes an extension in the longitudinal direction X of the motor vehicle, when viewed in the vertical direction Z of the motor vehicle, is shown. This radiant 21 is preferably at least 10 mm and at most 150 mm, measured from the center of the transverse leaf spring 2. Thus, said radiant extends from a center point 16 of the width 20 in the central region 10 in the longitudinal direction X of the motor vehicle to a center point 22 at the outer end.

FIG. 4 shows another inventive variant of the embodiment when viewed in the direction according to FIG. 2. In contrast to FIG. 2, an additional end piece 19 is formed in the respective end region 11, and this end piece also has a linear longitudinal extent 13 in a projection on the Y-Z plane. In this case the top view, i.e., when viewed in the vertical direction Z of the motor vehicle, can be configured analogous to FIG. 3.

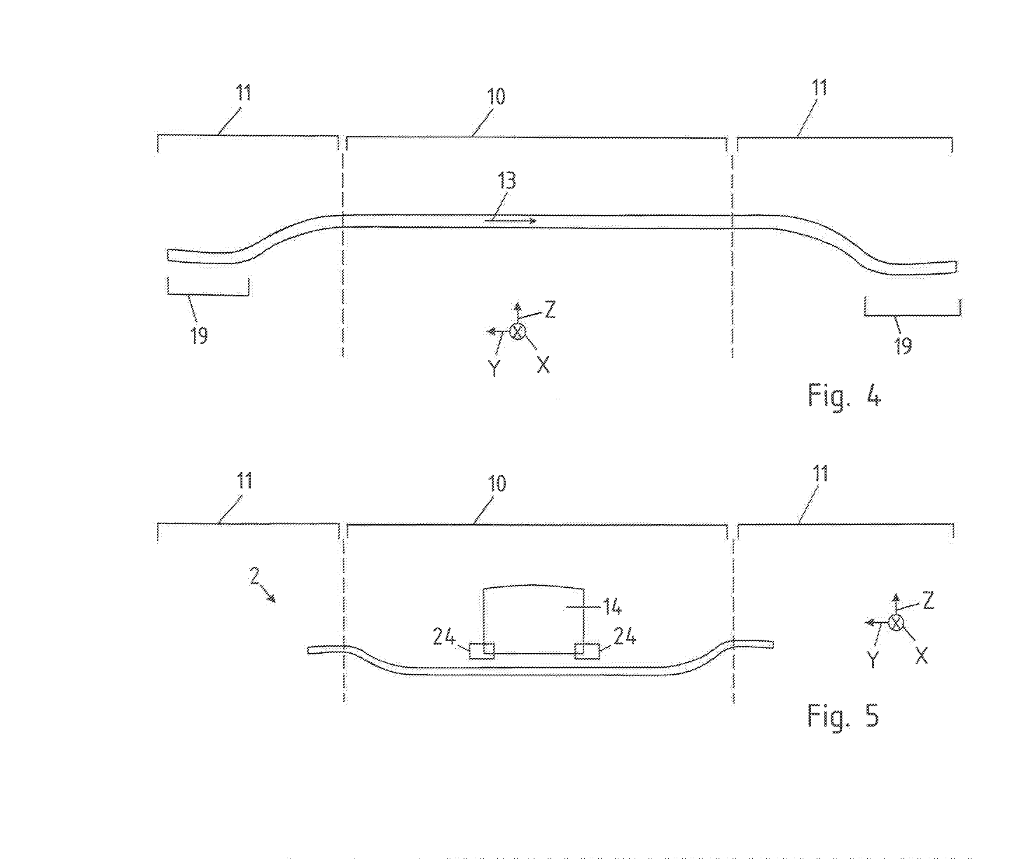

FIG. 5 shows an alternative variant of the embodiment of a transverse leaf spring 2. In this case the central region 10 is designed in a manner similar to the central region in FIG. 3. Thus, the central region 10 is formed, when viewed in the vertical direction Z of the motor vehicle, in such a way that it is curved about the vertical direction Z of the motor vehicle. In addition, the central region 10 is designed, when viewed in the longitudinal direction X of the motor vehicle, in such a way that it is curved downwards about the longitudinal direction X of the motor vehicle in the installed position. This arrangement in turn offers the option of bypassing a transfer case 14, which is indicated in the drawing, the installation space of the transfer case 14 and/or its suspensions 24 in relation to the vertical direction Z of the motor vehicle in the downward direction by means of the curvature about the longitudinal direction X of the motor vehicle. The end regions 11 are designed so as to be linear in relation to the longitudinal direction X of the motor vehicle, i.e., not curved about the longitudinal direction X of the motor vehicle. Then the end regions 11 may be formed preferably, when viewed in the vertical direction Z of the motor vehicle, in a manner analogous to the end regions in FIG. 3.

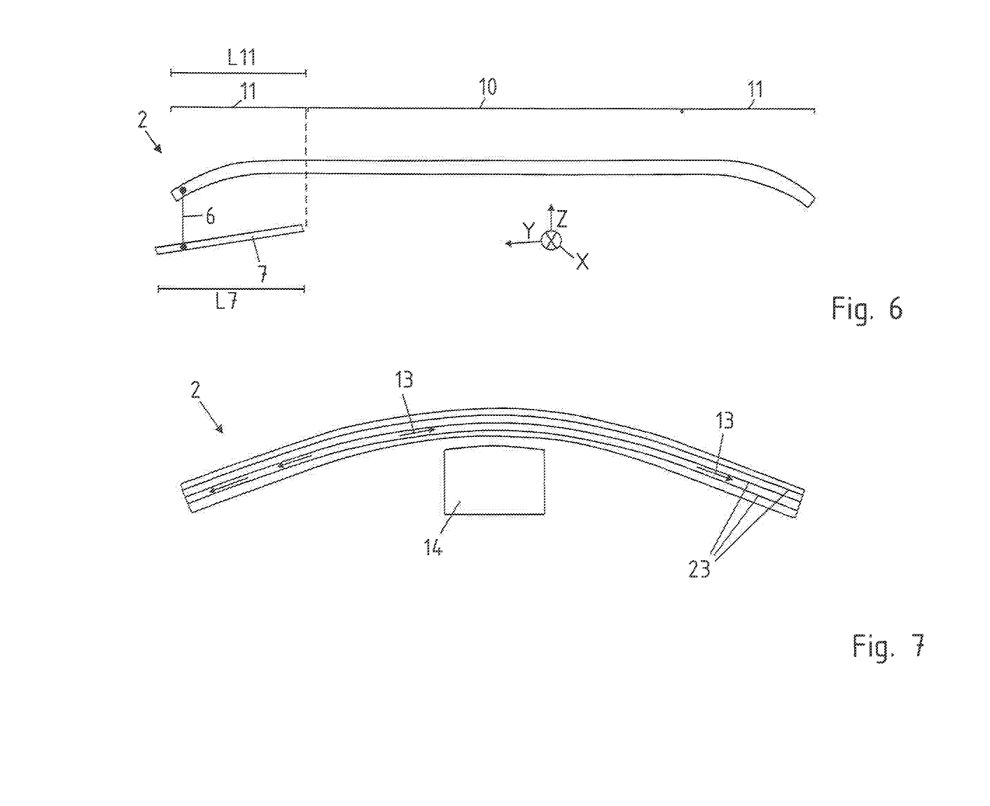

FIG. 6 shows an inventive transverse leaf spring 2 analogous to the one shown in FIG. 2. It can be seen that the length L11 of the end region 11 could be equal to 25% to 90% of the length L7 of the guide arm 7. This embodiment gives, depending on the kinematics selected, a transmission ratio of spring stroke to wheel movement. If, as a result, the attachment point at the guide arm 7 in relation to the transverse direction Y of the motor vehicle is selected farther outwards in the direction of the wheel carrier 8, then the spring stroke has almost the same value as the wheel movement. If the attachment point at the guide arm 7 in relation to the transverse direction Y of the motor vehicle is selected farther inwards, then the spring stroke is only a fraction of the wheel movement.

FIG. 7 shows a top view that is similar to the one shown in FIG. 3 when viewed in the vertical direction Z of the motor vehicle, It is easy to see here the unidirectional fiber orientation 23. This means that all of the fibers of the respective cross section are oriented parallel to the direction of the longitudinal extent 13.

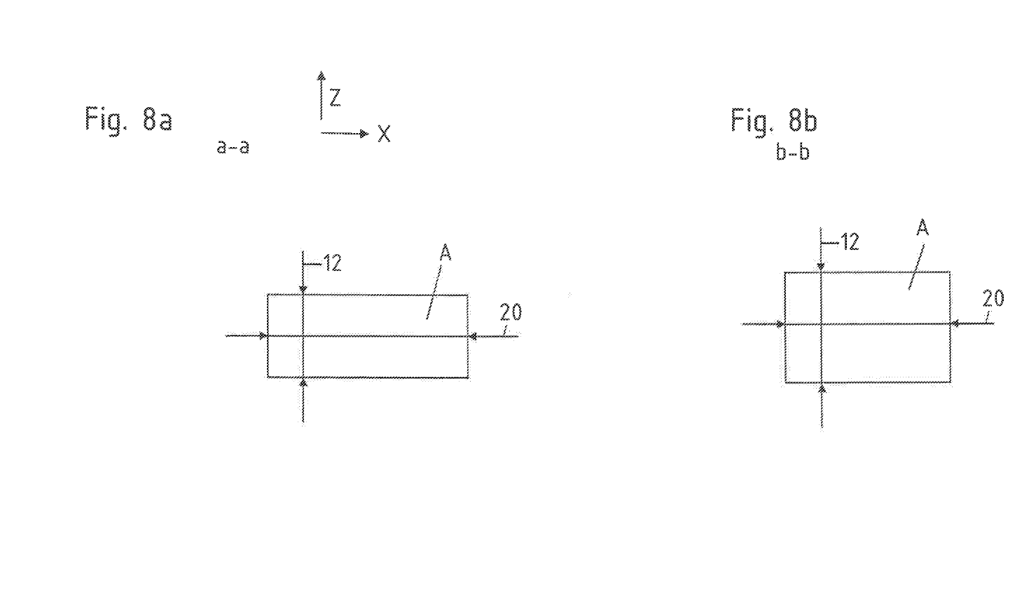

FIGS. 8a and b show a sectional view along the section lines a-a and b-b in FIG. 2. It will be seen in this case that the cross sectional area A, according to FIG. 8a and FIG. 8b, is the same. However, the width 20 and the thickness 12 vary. In contrast to FIG. 8a, in FIG. 8b the width 20 decreases, and the thickness 12 increases.

### LIST OF REFERENCE NUMERALS AND SYMBOLS

1—axle assembly

2—transverse leaf spring

3—axle subframe

4—bearing point

5—end with respect to 2

6—coupling rod

7—guide arm

8—wheel carrier

9—wheel

10—central region

11—end region

12—thickness with respect to 2

13—longitudinal extent with respect to 2

14—transfer case

15—straight line (connecting straight line with respect to 4)

16—center point

17—bearing orientation

18—longitudinal direction with respect to 2 in 4

19—end piece

20—width with respect to 2

21—radiant

22—center point at the outer end

23—fiber orientation

24—suspension

a4—distance

a5—distance

A—cross sectional area

B—width of the motor vehicle

L7—length with respect to 7

L11—length with respect to 11

R11—radius of curvature

R10—radius of curvature

α—angle

β—angle

γ—angle

X—longitudinal direction of the motor vehicle

Y—transverse direction of the motor vehicle

Z—vertical direction of the motor vehicle

1. A transverse leaf spring for a motor vehicle, wherein the transverse leaf spring is made of a fiber reinforced composite material, and the transverse leaf spring has a central region and end regions, adjoining the central region, wherein the transverse leaf spring in the installed position has a curvature about the longitudinal direction (X) of the motor vehicle and a curvature about the vertical direction (Z) of the motor vehicle, wherein the curvature about the longitudinal direction (X) of the motor vehicle is formed only in each of the end regions and that the curvature about the vertical direction (Z) of the motor vehicle is formed only in the central region.

2. The transverse leaf spring, as claimed in claim 1, wherein a bearing point is arranged in a transition from the central region to a respective end region.

3. The transverse leaf spring, as claimed in claim 1, wherein the central region in a projection on the Y-Z plane, defined by the transverse direction (Y) of the motor vehicle and the vertical direction (Z) of the motor vehicle, has a linear progression.

4. The transverse leaf spring, as claimed in claim 1, wherein the end regions in a projection on the X-Y plane, defined by the longitudinal direction (X) of the motor vehicle and the transverse direction (Y) of the motor vehicle, has a linear progression.

5. The transverse leaf spring, as claimed in claim 4, wherein a projection of the longitudinal extent of the end regions in the X-Y plane extends at an angle (α) of 2 deg. to 15 deg., oriented to the transverse direction (Y) of the motor vehicle.

6. The transverse leaf spring, as claimed in claim 1, wherein an external end piece of the respective end region has a linear progression in the Projection on the Y-Z plane that is defined by the transverse direction (Y) of the motor vehicle and the vertical direction (Z) of the motor vehicle.

7. The transverse leaf spring, as claimed in claim 1, wherein a projection of the curvature of the central region about the vertical direction (Z) of the motor vehicle on the X-Y plane extends with 10 mm to 150 mm in the longitudinal direction (X) of the motor vehicle from a center point up to the ends of the transverse leaf spring.

8. The transverse leaf spring, as claimed in claim 1, wherein the central region has a radius of curvature about the vertical direction (Z) of the motor vehicle of at least 150 mm to at most 2.000 mm, wherein the radius of curvature of the central region has a constant progression or a varying progression; the radius of curvature of the central region increases from a center point to the end regions.

9. The transverse leaf spring, as claimed in claim 1, wherein the transverse leaf spring has a bearing orientation at bearing points, wherein the bearing orientation extends at an angle of 90 deg. plus/minus 15 deg, relative to a longitudinal direction (18) of the transverse leaf spring at the bearing points.

10. The transverse leaf spring, as claimed in claim 1, wherein the transverse leaf spring has a unidirectional fiber orientation, which is oriented in each case in parallel to the longitudinal extent of the transverse leaf spring.

11. The transverse leaf spring, as claimed in claim 1, wherein the transverse leaf spring has a constant cross sectional area size over its entire length.

12. The transverse leaf spring, as claimed in claim 1, wherein the transverse leaf spring has a thickness, which is equal to 5% to 50% of the width, over its longitudinal length.

13. The transverse leaf spring, as claimed in claim 12, wherein the end regions have a thickness, which is equal to 5% to 50% of the width, over that longitudinal length; and that the central region of the transverse leaf spring has a thickness, which is equal to 5% to 30% of the width, over its longitudinal length.

14. The transverse leaf spring, as claimed in claim 1, wherein the length of the end regions in the transverse direction (Y) of the motor vehicle has 25% to 90% of the length of a guide arm.

15. An axle assembly for a motor vehicle, the axle assembly comprising an axle subframe; guide arms which are arranged in a relatively pivotable manner on the axle subframe; and a transverse leaf spring, which is coupled to said guide arms, as claimed in claim 1, wherein the transverse leaf spring has a curvature about the longitudinal direction (X) of the motor vehicle, and said transverse leaf spring is coupled in the region of its ends to the guide arms by means of attachment points of the guide arms and is coupled in an inner region, which, is spaced apart from the ends, to the axle subframe and/or the body of a motor vehicle by means of bearing points, wherein the transverse leaf spring has at least one additional curvature about the vertical direction (Z) of a motor vehicle, wherein a portion of the axle subframe and/or a transfer case is and/or are arranged in the region of a straight line connecting the bearing points.
